(19) United States
(12) Patent Application Publication
(10) Pub. No.: US 2025/0077283 A1
(43) Pub. Date: Mar. 6, 2025

(54) SYSTEM AND METHOD FOR MEMORY POOLING

(71) Applicant: Samsung Electronics Co., Ltd., Suwon-si (KR)

(72) Inventor: Sukhyun LIM, Suwon-si (KR)

(73) Assignee: Samsung Electronics Co., Ltd., Suwon-si (KR)

(21) Appl. No.: 18/669,688

(22) Filed: May 21, 2024

(30) Foreign Application Priority Data
Sep. 1, 2023 (KR) 10-2023-0116265

(51) Int. Cl. G06F 9/50; G06F 13/40

(52) U.S. Cl. CPC G06F 9/5022; G06F 9/5033; G06F 13/4022

(57) ABSTRACT

Provided are systems and methods for memory pooling. The system includes a plurality of memory devices, a host configured to communicate with the plurality of memory devices, and a switch connecting the host and the plurality of memory devices, the switch configured to receive a memory allocation request from the host, and allocate, in response to the received memory allocation request received from the host, at least one of the plurality of memory devices to the host based on grade information of the host and grade information of the plurality of memory devices.

### CROSS-REFERENCE TO RELATED APPLICATION

This application is based on and claims priority under 35 U.S.C. § 119 to Korean Patent Application No. 10-2023-0116265, filed on Sep. 1, 2023, in the Korean Intellectual Property Office, the disclosure of which is incorporated by reference herein in its entirety.

### BACKGROUND

The inventive concepts relate to memory pooling, and in particular, to memory pooling in a system using a compute express link (CXL) interface.

An apparatus configured to process data may carry out various operations by accessing a memory. For example, an apparatus may process data read from a memory or write processed data on a memory. Due to the performance and functions required for a system, various devices communicating with one another via a link that provides high bandwidth and low latency may be included in the system. A memory included in a system may be shared and accessed by two or more devices. Accordingly, the performance of a system may depend upon a communication efficiency among devices and a time taken to access the memory, as well as an operating speed of each apparatus.

### SUMMARY

The inventive concepts provide methods of determining a grade of a host according to importance of data processed by the host and allocating a memory device corresponding to the determined grade of the host to the host.

Aspects of various example embodiments are not limited thereto, and additional aspects will be set forth in part in the description which follows and, in part, will be apparent from the description, or may be learned by practice of the presented example embodiments.

According to some aspects of the inventive concepts, there is provided a system including a plurality of memory devices including a first memory device and a second memory device that is different from the first memory device, a host configured to communicate with the plurality of memory devices, and a switch connecting the host and the plurality of memory devices, the switch configured to receive a memory allocation request from the host, and allocate, in response to the received memory allocation request, at least one of the plurality of memory devices to the host based on grade information of the host and grade information of the plurality of memory devices.

According to some aspects of the inventive concepts, there is provided a method including receiving device information from a plurality of memory devices including a first memory device and a second memory device that is different from the first memory device, determining grades of the plurality of memory devices based on the device information, receiving a memory allocation request including category information of an application that is executed on a host from the host, determining a grade of the host based on the category information, and allocating at least one of the plurality of memory devices to the host based on grade information of the host and grade information of the plurality of memory devices.

According to some aspects of the inventive concepts, there is provided a system including a plurality of memory devices including a first memory device and a second memory device that is different from the first memory device, a plurality of hosts including a first host configured to communicate with the plurality of memory devices and a second host that is different from the first host, and a switch connecting the plurality of hosts and the plurality of memory devices, the switch configured to receive memory allocation requests from at least two of the plurality of hosts, and allocate, in response to the received memory allocation requests, at least one of the plurality of memory devices to each of the plurality of hosts based on grade information of the plurality of hosts and grade information of the plurality of memory devices.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram of a computing system including a storage system according to some example embodiments;

FIG. 2 is a block diagram showing elements in a computing system according to some example embodiments;

FIG. 3 is a block diagram of a computing system according to some example embodiments;

FIGS. 4A to 4D are block diagrams for describing allocation of a memory device to a host, according to some example embodiments;

FIG. 5 is a diagram for describing device information according to some example embodiments;

FIG. 6 is a flowchart for describing a method of allocating memory according to some example embodiments;

FIG. 7 is a block diagram of a computing system according to some example embodiments;

FIG. 8 is a block diagram of a computing system according to some example embodiments;

FIG. 9 is a block diagram of a computing system according to some example embodiments; and

FIG. 10 is a block diagram of a data center to which a computing system according to some example embodiments is applied.

### DETAILED DESCRIPTION

Hereinafter, one or more example embodiments of the inventive concepts will be described in detail with reference to accompanying drawings. When describing with reference to the drawings, the same or corresponding components are denoted by the same reference numerals, and overlapping descriptions thereof are omitted.

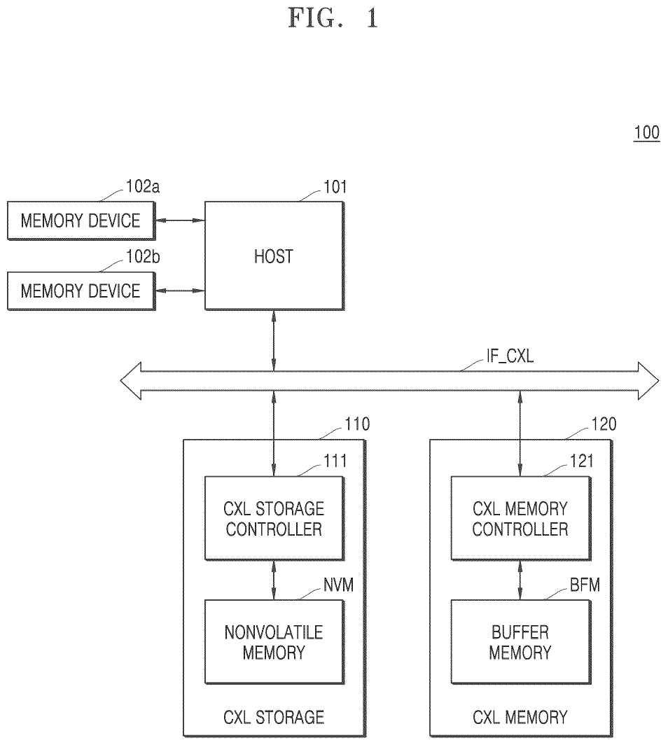

FIG. 1 is a block diagram of a computing system 100 including a storage system according to some example embodiments.

Referring to FIG. 1, the computing system 100 may include a host 101, a plurality of memory devices 102a and 102b, a compute express link (CXL) storage 110, and a CXL memory 120.

In some example embodiments, the computing system 100 may be included in a user device such as a personal computer, a laptop computer, a server, a media player, a digital camera, etc., or an automotive device such as a navigation, a block box, a vehicle electronic device, etc. Alternatively, the computing system 100 may include a mobile system such as a mobile phone, a smart phone, a tablet personal computer (PC), a wearable device, a health care device, or an Internet-of-things (IoT) device.

The host 101 may control overall operations of the computing system 100. In some example embodiments, the host 101 may be one of various processors such as a central processing unit (CPU), a graphic processing unit (GPU), a neural processing unit (NPU), a data processing unit (DPU), etc. In some example embodiments, the host 101 may include a single-core processor or a multi-core processor.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

The plurality of memory devices 102a and 102b may be used as a main memory or a system memory in the computing system 100. In some example embodiments, the plurality of memory devices 102a and 102b may each include dynamic random-access memory (DRAM) device, and may have a form factor of a dual in-line memory module (DIMM). However, the scope of the inventive concepts are not limited thereto, and the plurality of memory devices 102a and 102b may include a non-volatile memory such as a flash memory, phase-change random access memory (PRAM), resistive random-access memory (RRAM), magnetoresistive random access memory (MRAM), etc.

The plurality of memory devices 102a and 102b may directly communicate with the host 101 via a double data rate (DDR) interface. In some example embodiments, the host 101 may include a memory controller configured to control the plurality of memory devices 102a and 102b. However, the scope of the inventive concepts are not limited thereto, and the plurality of memory devices 102a and 102b may communicate with the host 102 via various interfaces.

The CXL storage 110 may include a CXL storage controller 111 and a non-volatile memory NVM. The CXL storage controller 111 may store data in the non-volatile memory NVM or transfer the data stored in the non-volatile memory NVM to the host 101, according to the control from the host 101. In some example embodiments, the non-volatile memory NVM may be a NAND flash memory, but the inventive concepts are not limited thereto.

The CXL memory 120 may include a CXL memory controller 121 and a buffer memory BFM. The CXL memory controller 121 may store data in the buffer memory BFM or transfer data stored in the buffer memory BFM to the host 101, according to the control from the host 101. In some example embodiments, the buffer memory BFM may include DRAM, but the inventive concepts are not limited thereto.

In some example embodiments, the host 101, the CXL storage 110, and the CXL memory 120 may be configured to share the same interface with one another. For example, the host 101, the CXL storage 110, and the CXL memory 120 may communicate with one another via a CXL interface IF_CXL. In some example embodiments, the CXL interface IF_CXL may denote a low-latency and high-bandwidth link enabling various connections among accelerators, memory devices, or various electronic devices by supporting coherency, memory access, and dynamic protocol multiplexing of an input/output protocol.

In some example embodiments, the CXL storage controller 111 may manage data stored in the non-volatile memory NVM by using map data. The map data may include information about a relationship between a logic block address managed by the host 101 and a physical block address of the non-volatile memory NVM.

In some example embodiments, the CXL storage 110 may not include an additional buffer memory for storing or managing map data. In some example embodiments, a buffer memory for storing or managing the map data may be desirable. In some example embodiments, at least some region of the CXL memory 120 may be used as a buffer memory of the CXL storage 110. In some example embodiments, a mapping table managed by the CXL storage controller 111 of the CXL storage 110 may be stored in the CXL memory 120. For example, at least some region of the CXL memory 120 may be allocated as a buffer memory (for example, an exclusive region for the CXL storage 110) of the CXL storage 110 by the host 101.

In some example embodiments, the CXL storage 110 may access the CXL memory 120 via the CXL interface IF_CXL. For example, the CXL storage 110 may store the mapping table in or read the mapping stable from the allocated region in the CXL memory 120. The CXL memory 120 may store data (e.g., map data) in the buffer memory BFM or transfer data (e.g., map data) stored in the buffer memory BFM to the CXL storage 110, according to the control from the CXL storage 110.

The CXL storage controller 111 of the CXL storage 110 may communicate with the host 101 and the CXL memory (that is, the buffer memory) via the CXL interface IF_CXL. In other words, the CXL storage controller 111 of the CXL storage 110 may communicate with the host 101 and the CXL memory 120 via the same kind of interface or a common interface, and may use some region of the CXL memory 120 as a buffer memory.

Hereinafter, for convenience of description, it is assumed that the host 101, the CXL storage 110, and the CXL memory 120 communicate with one another via the CXL interface IF_CXL. However, the scope of the inventive concepts are not limited thereto, that is, the host 101, the CXL storage 110, and the CXL memory 120 may communicate with one another based on various computing interfaces such as GEB-Z protocol, NVLink protocol, cache coherent interconnect for accelerators (CCIX) protocol, open coherent accelerator processor interface (CAPI) protocol, etc.

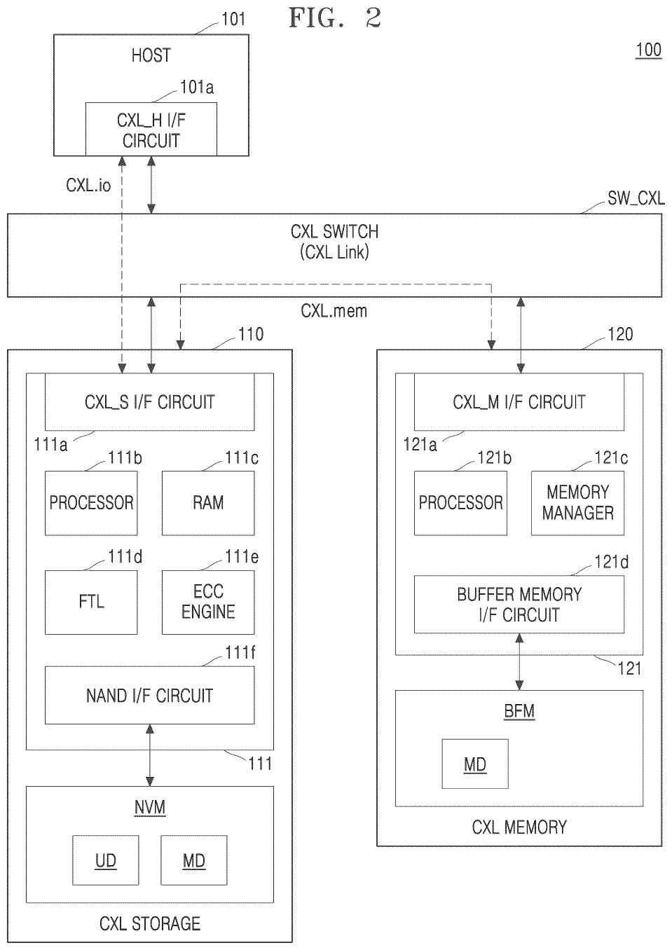

FIG. 2 is a block diagram showing elements in the computing system 100 according to some example embodiments. In detail, FIG. 2 is a block diagram showing in detail elements of the computing system 100 of FIG. 1. FIG. 2 may be described with reference to FIG. 1, and redundant descriptions may be omitted.

Referring to FIG. 2, the computing system 100 may include a CXL switch SW_CXL, the host 101, the CXL storage 110, and the CXL memory 120.

The CXL switch SW_CXL may be included in the CXL interface IF_CXL. The CXL switch SW_CXL may be configured to relay the communication among the host 101, the CXL storage 110, and the CXL memory 120. For example, when the host 101 and the CXL storage 110 communicate with each other, the CXL switch SW_CXL may be configured to transfer information such as a request, data, response, or signals transferred from the host 101 or the CXL storage 110 to the CXL storage 110 or the host 101. When the host 101 and the CXL memory 120 communicate with each other, the CXL switch SW_CXL may be configured to transfer information such as a request, data, response, or a signal transferred from the host 101 or the CXL memory 120 to the CXL memory 120 or the host 101. When the CXL storage 110 and the CXL memory 120 communicate with each other, the CXL switch SW_CXL may be configured to transfer information such as a request, data, response, or a signal transferred from the CXL storage 110 and the CXL memory 120 to the CXL memory 120 or the CXL storage 110. The host 101 may include a CXL host interface circuit 101a. The CXL host interface circuit 101a may communicate with the CXL storage 110 or the CXL memory 120 via the CXL switch SW_CXL.

The CXL storage 110 may include a CXL storage controller 111 and a non-volatile memory NVM. The CXL storage controller 111 may include a CXL storage interface circuit 111a, a processor 111b, a RAM 111c, a flash translation layer (FTL) 111d, an error correction code (ECC) engine 111e, and a NAND interface circuit 111f.

The CXL storage interface circuit 111a may be connected to the CXL switch SW_CXL. The CXL storage interface circuit 111a may communicate with the host 101 or the CXL memory 120 via the CXL switch SW_CXL.

The processor 111b may be configured to control overall operations of the CXL storage controller 111. The RAM 111c may be used as an operation memory or a buffer memory of the CXL storage controller 111.

The FTL 111d may perform various management operations for (for example efficiently) using the non-volatile memory NVM. For example, the FTL 111d may perform an address transformation between the logic block address managed by the host 101 and the physical block address used in the non-volatile memory NVM, based on the map data (or mapping table). The FTL 111d may perform a bad block management operation on the non-volatile memory NVM. The FTL 111d may perform a wear leveling operation on the non-volatile memory NVM. The FTL 111d may perform a garbage collection operation on the non-volatile memory NVM.

In some example embodiments, the FTL 111d may be implemented based on software, hardware, firmware, or a combination thereof. When the FTL 111d is implemented in the form of the software or firmware, program codes related to the FTL 111d may be stored in the RAM 111c and may be driven by the processor 111b. When the FTL 111d is implemented as hardware, hardware elements formed to perform the above various management operations may be implemented in the CXL storage controller 111.

The ECC engine 111e may perform an error detection and correction on the data stored in the non-volatile memory NVM. For example, the ECC engine 111e may generate a parity bit with respect to user data UD to be stored in the non-volatile memory NVM, and the generated parity bits may be stored in the non-volatile memory NVM along with the user data UD. When the user data UD is read from the non-volatile memory NVM, the ECC engine 111e may detect and correct an error in the user data UD by using the parity bits read from the non-volatile memory NVM along with the user data UD.

The NAND interface circuit 111f may control the non-volatile memory NVM so that the data may be stored in or read from the non-volatile memory NVM. In some example embodiments, the NAND interface circuit 111f may be implemented to comply with standard rules, for example, Toggle interface or ONFI, etc. For example, the non-volatile memory NVM may include a plurality of NAND flash devices, and when the NAND interface circuit 111f is implemented based on the Toggle interface, the NAND interface circuit 111f may communicate with the plurality of flash devices via a plurality of channels. The plurality of NAND flash devices may be connected to a plurality of channels via a multi-channel/multi-way structure.

The non-volatile memory NVM may store or output the user data UD according to the control from the CXL storage controller 111. The non-volatile memory NVM may store or output map data MD according to the control from the CXL storage controller 111. In some example embodiments, the map data MD stored in the non-volatile memory NVM may include mapping information corresponding to the entire user data UD stored in the non-volatile memory NVM. The map data MD stored in the non-volatile memory NVM may be stored in the CXL memory 120 during an initializing operation of the CXL storage 110.

The CXL memory 120 may include a CXL memory controller 121 and a buffer memory BFM. The CXL memory controller 121 may include a CXL memory interface circuit 121a, a processor 121b, a memory manager 121c, and a buffer memory interface circuit 122d.

The CXL memory interface circuit 121a may be connected to the CXL switch SW_CXL. The CXL memory interface circuit 121a may communicate with the host 101 or the CXL storage 110 via the CXL switch SW_CXL.

The processor 121b may be configured to control overall operations of the CXL memory controller 121. The memory manager 121c may be configured to manage the buffer memory BFM. For example, the memory manager 121c may be configured to convert the memory address (e.g., logic address or virtual address) accessed by the host 101 or the CXL storage 110 into the physical address about the buffer memory BFM. In some example embodiments, the memory address may be an address for managing the storage area of the CXL memory 120, and may be a logic address or virtual address designated and managed by the host 101.

The buffer memory interface 121d may control the buffer memory BFM so that the data may be stored in or read from the buffer memory BFM. In some example embodiments, the buffer memory interface circuit 122d may be implemented to comply with standard rules such as DDR interface, LPDDR interface, etc.

The buffer memory BFM may store the data or output the stored data according to the control from the CXL memory controller 121. In some example embodiments, the buffer memory BFM may be implemented to store the map data MD used in the CXL storage 110. The map data MD may be transferred from the CXL storage 110 to the CXL memory 120 during the initializing operation of the computing system 100 or the CXL storage 110.

As described above, the CXL storage 110 according to some example embodiments of the inventive concepts may store the map data MD that is desirable to manage the non-volatile memory NVM, in the CXL memory 120 connected thereto via the CXL switch SW_CXL (or CXL interface IF_CXL). After that, when the CXL storage 110 performs a reading operation according to the request from the host 101, the CXL storage 110 may read at least some of the map data MD from the CXL memory 120 via the CXL switch SW_CXL (or CXL interface IF_CXL) and may perform the reading operation based on the read map data MD. Alternatively, when the CXL storage 110 performs a writing operation according to a request from the host 101, the CXL storage 110 may perform the writing operation on the non-volatile memory NVM and update the map data MD. Here, the updated map data MD may be primarily stored in the RAM 111c of the CXL storage controller 111, and the map data MD stored in the RAM 111c may be transferred to the buffer memory BFM of the CXL memory 120 via the CXL switch SW_CXL (or CXL interface IF_CXL) and updated.

In some example embodiments, at least some of the regions in the buffer memory BFM of the CXL memory 120 may be allocated as a dedicated area for the CXL storage 110, and the remaining region may be used as a region accessible by the host 101.

In some example embodiments, the host 101 and the CXL storage 110 may communicate with each other via CXL.io that is an input/output protocol. CXL.io may have a non-consistent input/output protocol based on peripheral component interconnect express (PCIe). The host 101 and the CXL storage 110 may exchange user data or various information with each other by using CXL.io.

In some example embodiments, the CXL storage 110 and the CXL memory 120 may communicate with each other via CXL.mem that is a memory access protocol. CXL.mem may be a memory access protocol supporting memory access. The CXL storage 110 may access some region of the CXL memory 120 (e.g., region in which the map data MD is stored or dedicated area for the CXL storage) by using CXL.mem.

In some example embodiments, the host 101 and the CXL memory 120 may communicate with each other by using CXL.mem that is a memory access protocol. The host 101 may access the remaining region of the CXL memory 120 (e.g., a region other than the region where the map data MD is stored or a region other than the dedicated area for the CXL storage) by using CXL.mem.

The above-described access types (CXL.io, CXL.mem, etc.) are examples and the scope of the inventive concepts are not limited to the above examples.

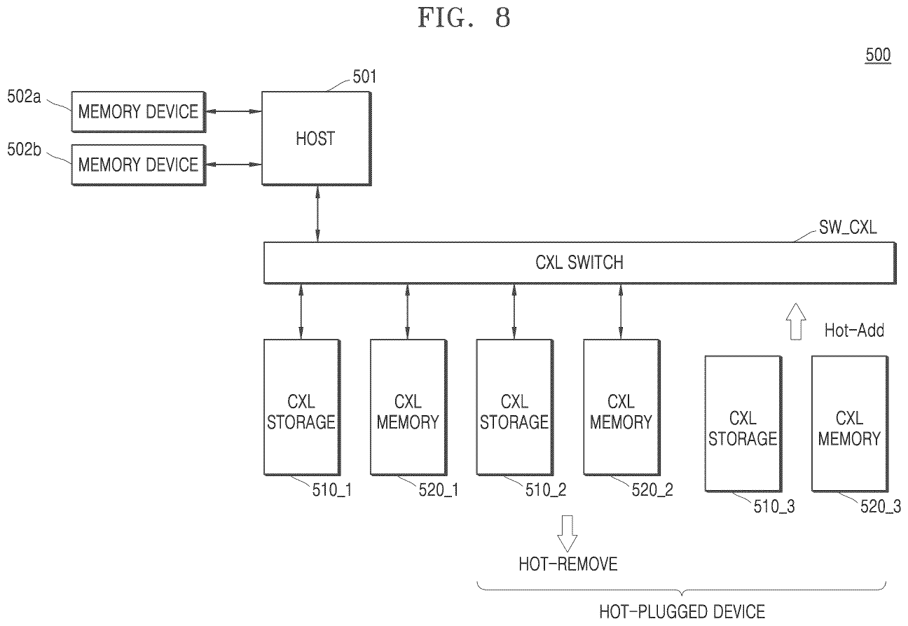

In some example embodiments, the CXL storage 110 and the CXL memory 120 may be mounted in a physical port (e.g., PCIe physical port) based on the CXL interface. In some example embodiments, the CXL storage 110 and the CXL memory 120 may be implemented based on E1.S, E1.L, E3.S, E3.L, and PCIe AIC (CEM) form factors. Alternatively, the CXL storage 110 and the CXL memory 120 may be implemented based on U.2 form factor, M.2 form factor, or other various types of PCIe-based form factors, or other various types of small form factors. The CXL storage 110 and the CXL memory 120 may support a hot-plug function to be attachable to/detachable from a physical port. The hot-plug function is described in detail below with reference to FIG. 8.

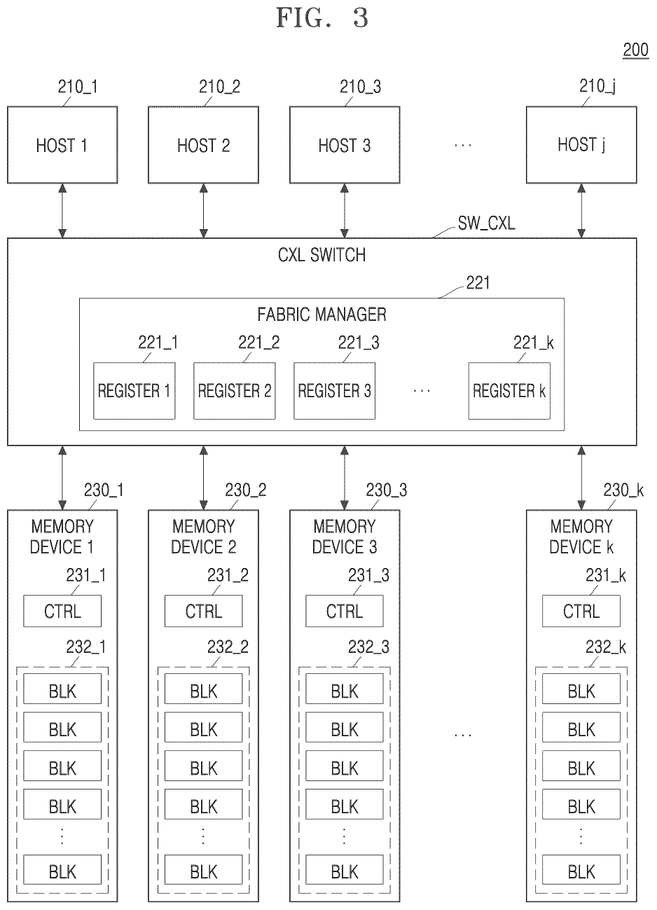

FIG. 3 is a block diagram of a computing system 200 according to some example embodiments.

In the specification, the computing system 200 may be briefly referred to as a system. Referring to FIG. 3, the computing system 200 may correspond to the computing system 100 of FIG. 2. The computing system 200 of FIG. 3 may include a plurality of hosts 210_1 to 210_j (j is 2 or greater integer), a CXL switch SW_CXL, and a plurality of memory devices 230_1 to 230_k (k is 2 or greater integer). Here, the number of the plurality of hosts 210_1 to 210_j and the number of plurality of memory devices 230_1 to 230_k may be different from each other. Each of the plurality of memory devices 230_1 to 230_k shown in FIG. 3 may correspond to a peripheral device communicable via the CXL storage 110, the CXL memory 120, or other CXL interface IF_CXL shown in FIGS. 1 and 2.

The plurality of hosts 210_1 to 210_j may be configured to communicate with the plurality of memory devices 230_1 to 230_k via the CXL switch SW_CXL. Here, the host that requires memory allocation may transfer a memory allocation request to the CXL switch SW_CXL. The memory allocation request provided by the host to the CXL switch SW_CXL may include a category information indicating kinds of applications executed on the host. For example, when a banking application is executed on a first host 210_1, the memory allocation request sent from the first host 210_1 to the CXL switch SW_CXL may include category information indicating that the application being executed on the first host 210_1 is a banking application. Also, for example, when a social network service (SNS) application is executed on a second host 210_2, the memory allocation request sent from the second host 210_2 to the CXL switch SW_CXL may include category information indicating that the application being executed on the second host 210_2 is an SNS application. As described above, the first host 210_1 and the second host 210_2 executing the banking application and the SNS application are examples, and applications that may be executed on the plurality of hosts 210_1 to 210_j may include various kinds of applications such as a security application, a media application, a game application, a browser application, an artificial intelligence (AI) application, etc.

The CXL switch SW_CXL of FIG. 3 may correspond to the CXL switch SW_CXL of FIG. 1. In the specification, the CXL switch SW_CXL may be briefly referred to as a switch. The CXL switch SW_CXL may be configured to provide connections between the plurality of hosts 210_1 to 210_j and the plurality of memory devices 230_1 to 230_k.

The CXL switch SW_CXL may include a fabric manager 221. The fabric manager 221 may allocate memory devices to the plurality of hosts 210_1 to 210_j based on grades of the plurality of hosts 210_1 to 210_j and grades of the plurality of memory devices 230_1 to 230_k. Here, the grade of the host indicates the processing priority of the host (for example, the application executed by the host, a plurality of applications assigned to the host, and/or the like). In some example embodiments, the higher the host's grade, the more priority the application running on the host may have. For example, if the grade of the first host 210_1 is the first grade and the grade of the second host 210_2 is the second grade, the application executed by the first host 210_1 may be an application that may be processed with priority over the application executed by the second host 210_2. A memory device of a higher grade may be allocated to the first host 210_1. The fabric manager 221 may determine the grade of the host that transmitted the memory allocation request based on category information of the application executed by the host that transmitted the memory allocation request. Here, the grade of a memory device indicates performance determined based on device information of the memory device. In some example embodiments, the higher the grade of the memory device, the faster the data input/output speed of the memory device. For example, when the grade of the first memory device 230_1 is the first grade and the grade of the second memory device 230_2 is the second grade, the first memory device 230_1 may have a faster data input/output speed than the second memory device 230_2. The fabric manager 221 may determine the grade of the memory device based on device information transmitted by the memory device to the fabric manager 221. In some example embodiments, the device information of the memory device may include memory device type information, bandwidth information, latency information, refresh period information, operating voltage information, and operating temperature information. In some example embodiments, the fabric manager 221 may allocate the memory device of greater grade to a host having greater grade. In the specification, the high grade may denote that the number of grade is less. For example, a first grade may be a grade greater than a second grade.

In response to the memory allocation requests received from the plurality of hosts 210_1 to 210_j, the fabric manager 221 may determine the grade of the host transmitting the memory allocation request and may generate host grade information indicating the determined grade. The fabric manager 221 may determine the grade of the host transmitting the memory allocation request, based on the category information about the application executed on the host transmitting the memory allocation request. The grade of the host may be one of first to N-th grades (N is 2 or greater integer).

In some example embodiments, the fabric manager 221 may determine the grade of the host transmitting the memory allocation request, in response to the memory allocation request from the host. Here, the grade of the host may be determined according to a grade determination reference value corresponding to the category information about the application executed on the host. The grade determination reference value may be defined in advance and stored in the fabric manager 221. For example, when an application requiring fast data process such as a banking application or a security application is being executed on the first host 210_1 transmitting a memory allocation request to the fabric manager 221, the fabric manager 221 may determine the grade of the first host 210_1 to be a greater grade. For example, the fabric manager 221 may determine the grade of the first host 210_1 as a first grade. Also, for example, when an application that does not require fast data process as compared with the applications corresponding to the first grade, such as an SNS application, is being executed on the second host 210_2 transmitting a memory allocation request to the fabric manager 221, the fabric manager 221 may determine the grade of the second host 210_2 to be less than the first grade. For example, the fabric manager 221 may determine the grade of the second host 210_2 to be a second grade. As described above, the fabric manager 221 may determine the grade of the host according to the category information about the application executed on the host.

The fabric manager 221 may determine the grades of the plurality of memory devices 230_1 to 230_k, and may generate memory device grade information indicating the determined grades. The fabric manager 221 may determine a grade of a corresponding memory device based on device information sent from the corresponding memory device to the fabric manager 221. The grade of the memory device may be one of first to M-th grades (M is 2 or greater integer).

When the memory device is connected to the CXL switch SW_CXL, the fabric manager 221 may determine the grade of the memory device connected to the CXL switch SW_CXL based on the device information received from the memory device. For example, when the first memory device 230_1 is connected to the CXL switch SW_CXL, a first memory controller 231_1 of the first memory device 230_1 may provide the fabric manager 221 with first device information indicating the state of the first memory device 230_1. The fabric manager 221 may determine the grade of the first memory device 230_1 based on the first device information received from the first memory controller 231_1, and may generate first memory device grade information indicating the grade of the first memory device 230_1. For example, according to some example embodiments, there may be an increase in speed, accuracy, and/or power efficiency of communication and operation of the device based on the above methods. Therefore, the improved devices and methods overcome the deficiencies of the conventional devices and methods of memory devices related to including usage of multiple memory devices while reducing resource consumption, data accuracy, and increasing data clarity. Further, there is an improvement in communication control and reliability between different memory devices by providing the ability disclosed above.

In some example embodiments, the device information may be referred to as device status information, status information, or health information. The device information is described in more detail below with reference to FIG. 5.

The fabric manager 221 may include a plurality of device status registers 221_1 to 221_k. In the specification, the device status register may be simply referred to as a register. Each device status register may include device information about a memory device corresponding to each device status register. For example, the first device status register 221_1 may store device information about the first memory device 230_1, and the k-th device status register 221_k may store device information about the k-th memory device 230_k.

In some example embodiments, the fabric manager 221 may be implemented based on software, hardware, firmware, or a combination thereof.

The plurality of memory devices 230_1 to 230_k may respectively include memory controllers 231_1 to 231_k and memory pools 232_1 to 232_k, and each of the memory pools may include a plurality of memory blocks. For example, the first memory device 230_1 may include a first memory controller 231_1 and a first memory pool 232_1. The first memory pool 232_1 may include a plurality of memory blocks. Each of the memory blocks may be a unit for logically dividing the first memory pool 232_1. In the specification, allocating a memory device to a host may denote allocating at least one of the memory blocks included in the memory pool of the memory device to the host.

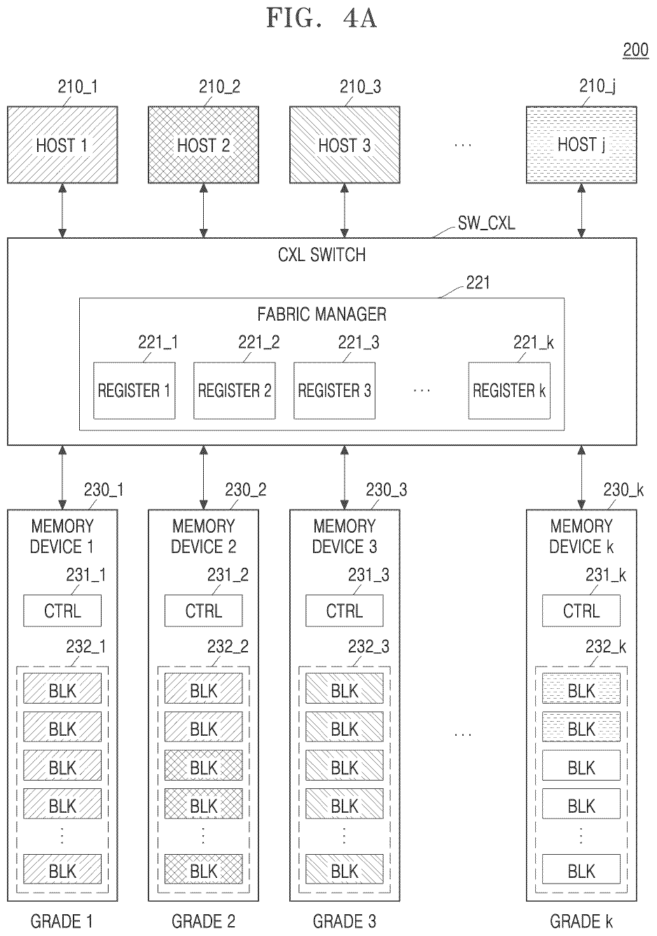

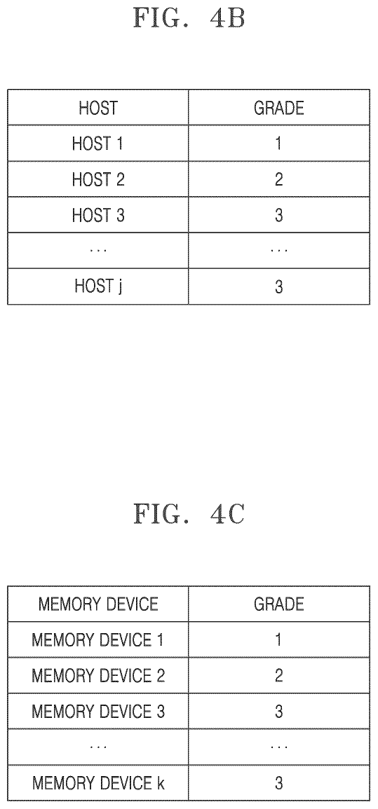

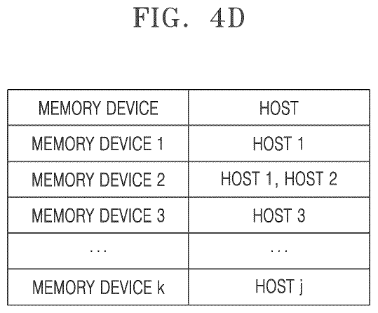

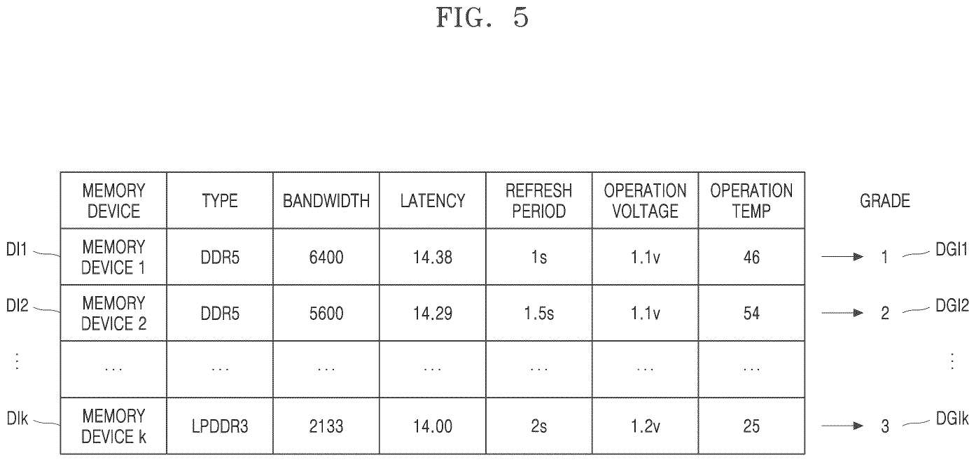

FIGS. 4A to 4D are block diagrams for describing allocating of a memory device to a host, according to some example embodiments. In detail, FIG. 4A is a diagram for describing a method of allocating a memory device to each of the plurality of hosts 210_1 to 210_j included in the computing system 200. FIG. 4B is a diagram showing a grade of each of the plurality of hosts 210_1 to 210_j. FIG. 4C is a diagram showing a grade of each of the plurality of memory devices 230_1 to 230_k. FIG. 4D is a diagram for describing allocations between the plurality of hosts 210_1 to 210_j and the plurality of memory devices 230_1 to 230_k. FIGS. 4A to 4D may be described with reference to FIG. 3, and redundant descriptions may be omitted.

Referring to FIG. 4A, the fabric manager 221 may allocate the memory devices to the plurality of hosts 210_1 to 210_j as shown in FIG. 4D, based on the grades of the plurality of hosts 210_1 to 210_j and the grades of the plurality of memory devices 230_1 to 230_k.

It is assumed that the grades of the plurality of hosts 210_1 to 210_j shown in FIG. 4A are the same as those of FIG. 4B. That is, it is assumed that the grade of the first host 210_1 is the first grade, the grade of the second host 210_2 is the second grade, and the grades of the third host 210_3 to j-th host 210_j are third grades. Also, it is assumed that the grades of the plurality of memory devices 230_1 to 230_k shown in FIG. 4A are the same as those of FIG. 4C. That is, it is assumed that the grade of the first memory device 230_1 is the first grade, the grade of the second memory device 230_2 is the second grade, and the grades of the third memory device 230_3 to k-th memory device 230_k are the third grades.

In some example embodiments, because the first host 210_1 has the first grade, the fabric manager 221 may allocate the memory device of highest grade, that is, first grade, to the first host 210_1. In other words, the fabric manager 221 may allocate the first memory device 230_1 to the first host 210_1.

In some example embodiments, when the memory required by the first host 210_1 is greater than an available memory of the first memory 230_1, the fabric manager 221 may allocate a memory device of the first grade that is the same as the grade of the first memory device 230_1 to the first host 210_1. Here, when there is not another memory device having the same grade as that of the first memory device 230_1 in the computing system 200 or when there is no available memory that may be allocated to the first host 210_1, a memory device having a next grade may be allocated to the first host 210_1. That is, as shown in FIG. 4A, the fabric manager 221 may allocate the second memory device 230_2 having the second grade to the first host 210_1.

In some example embodiments, because the second host 210_2 has the second grade, the fabric manager 221 may allocate to the second host 210_2 a memory device having the grade that is equal to or less than that of the memory device allocated to the first host 210_1. For example, the fabric manager 221 may allocate the second memory device 230_2 having the second grade to the second host 210_2.

In some example embodiments, because the third host 210_3 has the third grade, the fabric manager 221 may allocate to the third host 210_3 a memory device having the grade that is equal to or less than that of the memory device allocated to the second host 210_2. For example, the fabric manager 221 may allocate the third memory device 230_3 having the third grade to the third host 210_3. In some example embodiments, the first to j-th hosts 210_1 to 10_j may read/write data to/from the allocated blocks of the memory devices. For example, by allocating some or all of a memory device to a host, the host may then control writing data and/or reading data, as well as perform other actions related to the allocated blocks.

FIG. 5 is a diagram for describing device information according to some example embodiments. FIG. 5 may be described with reference to FIGS. 3 to 4D, and redundant descriptions may be omitted.

A table of FIG. 5 shows device information and device grade information corresponding to each of the plurality of memory devices 230_1 to 230_k. The device information may include type information, bandwidth information, latency information, refresh cycle information, operating voltage information, operating temperature information, etc. of each memory device. For example, first device information DI1 may include information indicating a type, a bandwidth, a latency, a refresh cycle, an operating voltage, and an operating temperature of the first memory device 230_1.

In some example embodiments, the fabric manager 221 may score each item in the device information and determine the grade of each memory device according to the score. For example, the fabric manager 221 may store a minimum reference value defined in advance for determining each memory device as the first grade. Here, when a value scored in consideration of all the bandwidth information, the latency information, the refresh cycle information, the operating voltage information, and the operating temperature information about the first memory device 230_1 is greater than a minimum reference value of the first grade, the fabric manager 221 may determine the grade of the first memory device 230_1 as the first grade and may generate first memory device grade information DGI1 indicating the grade of the first memory device 230_1. As described above, the fabric manager 221 may store the minimum reference values for determining the second to M-th grades (M is 2 or greater integer) of each memory device.

In some example embodiments, the first memory controller 231_1 of the first memory device 230_1 may provide the first device information DI1 to the fabric manager 221. The fabric manager 221 may determine the grade of the first memory device 230_1 based on the first device information DI1. The fabric manager 221 may generate the first memory device grade information DGI1 indicating the grade of the first memory device 230_1. The fabric manager 221 may store the first device information DI1 and the first memory device grade information DGI1 in the first device status register 221_1.

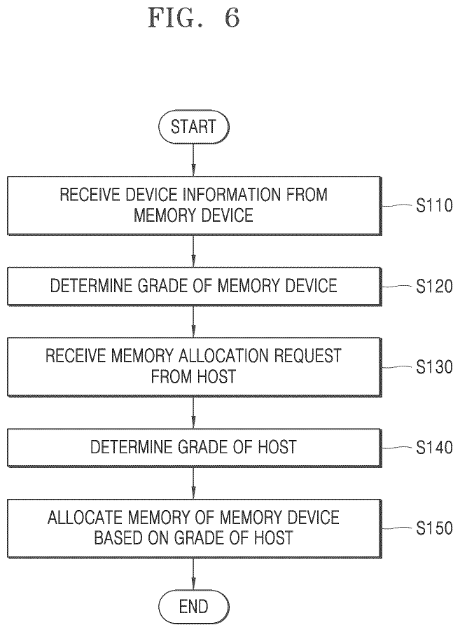

FIG. 6 is a flowchart for describing a method of allocating memory according to some example embodiments. FIG. 6 may be described with reference to FIG. 3, and redundant descriptions may be omitted.

In operation S110, the fabric manager 221 may receive device information from the plurality of memory devices 230_1 to 230_k.

In some example embodiments, the fabric manager 221 may receive device information from the first memory device 230_1 and the second memory device 230_2 that is different from the first memory device.

In operation S120, the fabric manager 221 may determine the grade of each of the plurality of memory devices 230_1 to 230_k based on the device information received in operation S110.

In some example embodiments, the fabric manager 221 may determine the grade of the first memory device 230_1 to be one of the first to M-th grades (M is 2 or greater integer) based on the first device information DI1 received from the first memory device 230_1. The fabric manager 221 may generate the first memory device grade information DGI1 indicating the grade of the first memory device 230_1.

In some example embodiments, the fabric manager 221 may store the first device information DI1 and the first memory device grade information DGI1 in the first device status register 221_1.

In some example embodiments, the fabric manager 221 may determine the grade of a memory device when the corresponding memory device is connected to the CXL switch SW_CXL. For example, the fabric manager 221 may determine the grade of the first memory device 230_1 when the first memory device 230_1 is connected to the CXL switch SW_CXL. Likewise, the fabric manager 221 may determine the grade of the second memory device 230_2 when the second memory device 230_2 is connected to the CXL switch SW_CXL.

In operation S130, the fabric manager 221 may receive a memory allocation request from a host.

In some example embodiments, from among the plurality of hosts 210_1 to 210_j, a host requiring memory allocation may send a memory allocation request to the fabric manager 221. For example, the first host 210_1 may transmit to the fabric manager 221 a memory allocation request including category information about the application being executed on the first host 210_1.

In operation S140, the fabric manager 221 may determine the grade of the host transmitting the memory allocation request that is received in operation S130.

In some example embodiments, the fabric manager 221 may determine the grade of the host in response to the memory allocation request received from the host. For example, when the first host 210_1 transmits the memory allocation request to the fabric manager 221, the fabric manager 221 may determine the grade of the first host 210_1.

In some example embodiments, the fabric manager 221 may determine the grade of the host based on the category information about the application executed on the host.

In operation S150, the fabric manager 221 may allocate a memory device to the host, based on the grade of the host and the grade of the memory device.

In some example embodiments, when the first host 210_1 has the first grade, the first memory device 230_1 may be allocated to the host 210_1, and when the first host 210_1 has the second grade, the second memory device 230_2 may be allocated to the first host 210_1. Here, the grade of the first memory device 230_1 may be greater than that of the second memory device 230_2. For example, the first memory device 230_1 may have the first grade and the second memory device 230_2 may have the second grade.

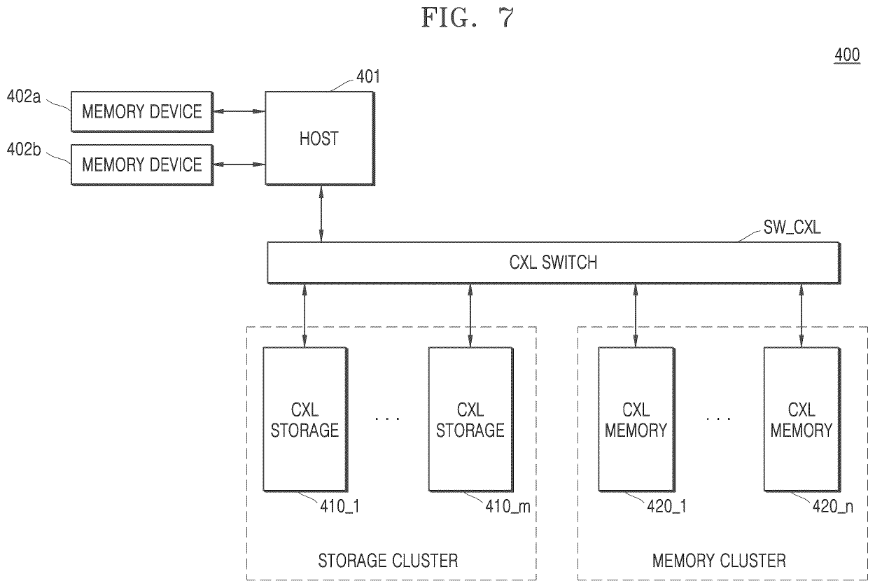

FIG. 7 is a block diagram of a computing system 400 according to some example embodiments. Hereinafter, detailed descriptions about the elements provided in the above embodiments are omitted for convenience of description.

Referring to FIG. 7, the computing system 400 may include a host 401, a plurality of memory devices 302a and 302b, the CXL switch SW_CXL, a plurality of CXL storages 410_1 to 410_m, and a plurality of CXL memories 420_1 to 420_n.

The host 401 may be directly connected to the plurality of memory devices 402a and 402b. The host 401, the plurality of CXL storages 410_1 to 410_m, and the plurality of CXL memories 420_1 to 420_n may be connected to the CXL switch SW_CXL, and may communicate with one another via the CXL switch SW_CXL.

In some example embodiments, the host 401 may manage the plurality of CXL storages 410_1 to 410_m as one storage cluster and manage the plurality of CXL memories 420_1 to 420_n as one memory cluster. The host 401 may allocate some region of the memory cluster to one storage cluster as a dedicated area (that is, an area for storing map data of the storage cluster). Alternatively, the host 401 may allocate regions in the plurality of CXL memories 420_1 to 420_n to the plurality of CXL storages 410_1 to 410_m as dedicated areas, respectively.

FIG. 8 is a block diagram of a computing system 500 according to some example embodiments. Hereinafter, detailed descriptions about the elements provided in the above embodiments are omitted for convenience of description.

Referring to FIG. 8, the computing system 500 may include a host 501, a plurality of memory devices 502a and 502b, the CXL switch SW_CXL, a plurality of CXL storages 510_1, 510_2, and 510_3, and a plurality of CXL memories 520_1, 520_2, and 520_3.

The host 501 may be directly connected to the plurality of memory devices 502a and 502b. The host 501, the plurality of CXL storages 510_1 and 510_2, and the plurality of CXL memories 520_1 and 520_2 may be connected to the CXL switch SW_CXL, and may communicate with one another via the CXL switch SW_CXL. Similarly to the above description, some regions of the CXL memories 520_1 and 520_2 may be allocated as dedicated areas for the CXL storages 510_1 and 510_2.

In some example embodiments, during the driving of the computing system 500, the CXL storages 510_1 and 510_2 or the CXL memories 520_1 and 520_2 may be partially released from the connection to the CXL switch SW_CXL or removed from the CXL switch SW_CXL (hot-remove). Alternatively, during the driving of the computing system 500, the CXL storage 510_3 or the CXL memory 520_3 may be connected to or added to the CXL switch SW_CXL (hot-add). In some example embodiments, the host 501 may re-perform the memory allocation by performing initializing operations on the devices connected to the CXL switch SW_CXL via a reset operation or hot-plug operation. That is, the CXL storage and the CXL memory according to some example embodiments may support the hot-plug function, and through various connections, a storage capacity and memory capacity of the computing system may be expanded.

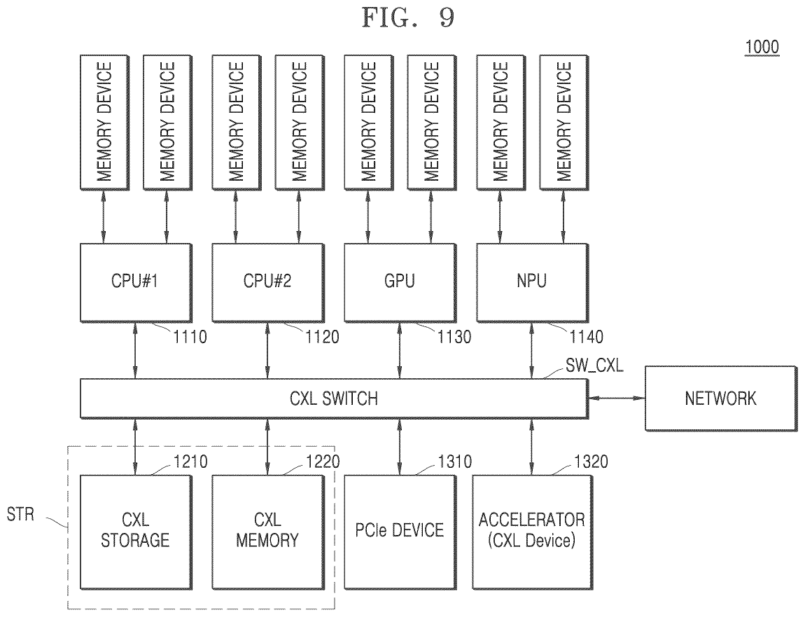

FIG. 9 is a block diagram of a computing system 1000 according to some example embodiments. Hereinafter, detailed descriptions about the elements provided in the above embodiments are omitted for convenience of description.

Referring to FIG. 9, the computing system 1000 may include a first central processing unit (CPU) 1110, a second CPU 1120, a graphic processing unit (GPU) 1130, a neural processing unit (NPU) 1140, the CXL switch SW_CXL, a CXL storage 1210, a CXL memory 1220, a PCIe device 1310, and an accelerator (CXL device) 1320.

The first CPU 1110, the second CPU 1120, the GPU 1130, the NPU 1140, the CXL storage 1210, the CXL memory 1220, the PCIe device 1310, and the accelerator (CXL device) 1320 may be commonly connected to the CXL switch SW_CXL, and may communicate with one another via the CXL switch SW_CXL.

In some example embodiments, each of the first CPU 1110, the second CPU 1120, the GPU 1130, and the NPU 1140 may be the host described above with reference to FIGS. 1 to 8, and may be directly connected to an individual memory device.

In some example embodiments, the CXL storage 1210 and the CXL memory 1220 may correspond to the CXL storage and the CXL memory described above with reference to FIGS. 1 to 8, and at least partial region of the CXL memory 1220 may be allocated as a dedicated area for the CXL storage 1210 by one or more of the first CPU 1110, the second CPU 1120, the GPU 1130, and the NPU 1140. That is, the CXL storage 1210 and the CXL memory 1220 may be used as storage spaces STR of the computing system 1000.

In some example embodiments, the CXL switch SW_CXL may be connected to the PCIe device 1310 or the accelerator 1320 that are configured to support various functions, and the PCIe device 1310 or the accelerator 1320 may communicate with each of the first CPU 1110, the second CPU 1120, the GPU 1130, and the NPU 1140 or may access the storage space STR including the CXL storage 1210 and the CX memory 1220 via the CXL switch SW_CXL.

In some example embodiments, the CXL switch SW_CXL may be connected to an external network or fabric and may communicate with an external server via the external network or fabric.

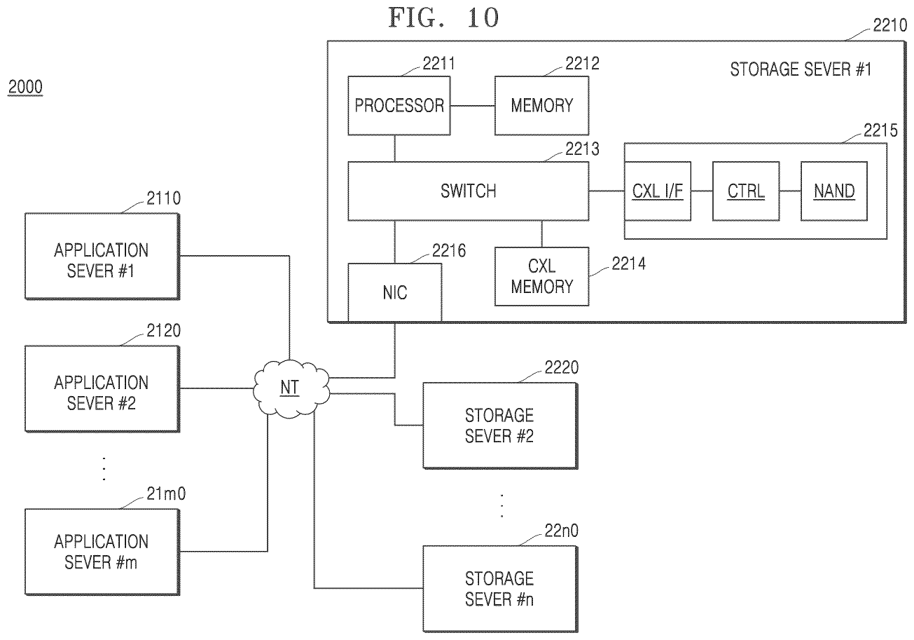

FIG. 10 is a block diagram of a data center 2000 to which a computing system according to some example embodiments is applied. Hereinafter, detailed descriptions about the elements provided in the above embodiments are omitted for convenience of description.

Referring to FIG. 10, the data center 2000 is facility that collects various data and provides services and may be referred to as a data storage center. The data center 2000 may be a system for operating a search engine and a database, and may be a computing system used in companies such as banks, or government organizations. The data center 2000 may include application servers 2110 to 12m0 and storage servers 2210 to 22n0. The number of application servers and the number of storage servers may be variously selected according to embodiments, and the number of the application servers may differ from the number of the storage servers.

Hereinafter, a structure of the first storage server 2210 is mainly described below. Each of the application servers 2110 to 21m0 and each of the storage servers 2210 to 22n0 may have similar structures from each other, and the application servers 2110 to 21m0 and the storage servers 2210 to 22n0 may communicate with one another via a network NT.

The first storage server 2210 may include a processor 2211, a memory 2212, a switch 2213, a storage 2215, a CXL memory 2214, and a network interface card (NIC) 2216. The processor 2211 may control overall operations of the first storage server 2210 and may access the memory 2212 to execute instructions loaded on the memory 2212 or process data. Examples of the memory 2212 may include Double Data Rate Synchronous DRAM (DDR SDRAM), High Bandwidth Memory (HBM), Hybrid Memory Cube (HMC), Dual In-line Memory Module (DIMM), Optane DIMM, and/or Non-Volatile DIMM (NVMDIMM). The processor 2211 and the memory 2212 may be directly connected to each other, and the number of processors 2211 and the number of the memories 2212 included in one storage server 2210 may be variously selected.

In some example embodiments, the processor 2211 and the memory 2212 may provide a processor-memory pair. In some example embodiments, the number of processors 2211 may differ from the number of memories 2212. The processor 2211 may include a single-core processor or a multi-core processor. The above descriptions about the storage server 2210 may be similarly applied to each of the application servers 2110 to 21m0.

The switch 2213 may be configured to relay or route communications among various elements included in the first storage server 2210. In some example embodiments, the switch 2213 may include the CXL switch SW_CXL described above with reference to FIGS. 1 to 9. That is, the switch 2213 may be implemented based on the CXL protocol.

The CXL memory 2214 may be connected to the switch 2213. In some example embodiments, the CXL memory 2214 may be used as a memory expander for the processor 2211. Alternatively, the CXL memory 2214 may be allocated as an exclusive memory or a buffer memory for the storage device 2215 as described above with reference to FIGS. 1 to 9.

The storage device 2215 may include a CXL interface circuit CXL_IF, a controller CTRL, and a NAND flash NAND. The storage device 2215 may store data or output stored data according to a request from the processor 2211. In some example embodiments, the storage device 2215 may include the CXL storage described above with reference to FIGS. 1 to 9. In some example embodiments, the storage device 2215 may be allocated with at least partial region of the CXL memory 2214 as a dedicated area similarly to the description provided with reference to FIGS. 1 to 9, and may use the dedicated area as a buffer memory (that is, the map data is stored in the CXL memory 2214).

According to some example embodiments, the application servers 2210 to 21m0 may not include the storage 2215. The storage server 2210 may include at least one storage device 2215. The number of storage devices 2215 included in the storage server 2210 may be variously selected according to the example embodiments.

The NIC 2216 may be connected to the CXL switch SW_CXL. The NIC 2216 may communicate with other storage servers 2220 to 22n0 or other application servers 2110 to 21m0 via the network NT.

In some example embodiments, the NIC 2216 may include a network interface card, a network adaptor, etc. The NIC 2216 may be connected to the network NT via a wired interface, a wireless interface, a Bluetooth interface, an optical interface, etc. The NIC 2216 may include an internal memory, a digital signal processor (DSP), a host bus interface, etc., and may be connected to the processor 2211 and/or the switch 2213 via the host bus interface. In some example embodiments, the NIC 2216 may be integrated with at least one of the processor 2211, the switch 2213, and the storage device 2215.

In some example embodiments, the network NT may be implemented by using Fibre channel (FC), Ethernet, etc. Here, the FC is a medium used to transfer data at relatively high speed, and may use an optical switch providing high performance/high availability. According to the accessing type of the network NT, the storage servers may be each provided as a file storage, a block storage, or an object storage.

In some example embodiments, the network NT may include a storage-exclusive network such as a storage area network (SAN). For example, the SAN may include an FC-SAN that may use the FC network and may be implemented according to FC protocol (FCP). Otherwise, the SAN may include an IP-SAN that may use transmission control protocol/Internet protocol (TCP/IP) network and may be implemented according to a small computer system interface (SCSI) over TCP/IP or Internet SCSI (iSCSI) protocol. In some example embodiments, the network NT may include a general network such as a TCP/IP network. For example, the network NT may be implemented according to a protocol such as FC over Ethernet (FCOE), network attached storage (NAS), non-volatile memory express (NVMe) over fabrics (NVMe-oF), etc.

In some example embodiments, at least one of the application servers 2110 to 21m0 may store data that is requested to be stored from a user or a client in one of the storage servers 2210 to 22n0 via the network NT. At least one of the application servers 2110 to 21m0 may obtain the data that is requested to be read from the user or the client from one of the storage servers 2210 to 22n0 via the network NT. For example, at least one of the application servers 2110 to 21m0 may be implemented as a web server, a database management system (DBMS), etc.

In some example embodiments, at least one of the application servers 2110 to 21m0 may access the memory, CXL memory, or the storage device included in another application server via the network NT, or may access the memories, CXL memories, or storage devices included in the storage servers 2210 to 22n0 via the network NT. As such, at least one of the application servers 2110 to 21m0 may perform various operations on the data stored in other application servers and/or storage servers. For example, at least one of the application servers 2110 to 21m0 may execute an instruction for moving or copying data between different application servers and/or the storage servers. Here, the data may be moved from the storage devices of the storage servers to the memories or CXL memories of the application servers directly or through the memories or the CXL memories of the storage servers. The data moved through the network may be encrypted for security or privacy.

In some example embodiments, the storage device included in at least one of the application servers 2110 to 21m0 and the storage servers 2210 to 22n0 may receive allocation of the CXL memory included in at least one of the application servers 2110 to 21m0 and the storage servers 2210 to 22n0 as a dedicated area, and the storage device may use the dedicated area as a buffer memory (that is, storing map data). For example, the storage device 2215 included in the storage server 2210 may receive the allocation of the CXL memory included in another storage server (e.g., 22m0), and may access the CXL memory included another storage server (e.g., 22m0) via the switch 2213 and the NIC 2216. In some example embodiments, the map data with respect to the storage device 2215 of the first storage server 2210 may be stored in the CXL memory of another storage server 22m0. That is, the storage devices and the CXL memories of the data center according to the inventive concepts may be connected and implemented in various ways.

While the inventive concepts has been particularly shown and described with reference to example embodiments thereof, it will be understood that various changes in form and details may be made therein without departing from the spirit and scope of the following claims.

What is claimed is:

1. A system comprising:
a plurality of memory devices including a first memory device and a second memory device that is different from the first memory device;
a host configured to communicate with the plurality of memory devices; and
a switch connecting the host and the plurality of memory devices, the switch configured to
receive a memory allocation request from the host, and
allocate, in response to the received memory allocation request, at least one of the plurality of memory devices to the host based on grade information of the host and grade information of the plurality of memory devices.

2. The system of claim 1, wherein the switch is further configured to
receive device information from the first memory device,
determine a grade of the first memory device as one of first to M-th grades (M is 2 or greater integer) based on the device information received from the first memory device, and
generate memory device grade information indicating the grade of the first memory device.

3. The system of claim 2, wherein the device information includes at least one of device type information, bandwidth information, latency information, cell capacity information, voltage information, and temperature information corresponding to the first memory device.

4. The system of claim 2, wherein the switch includes a device information register configured to store first device information indicating status of the first memory device and the grade information of the first memory device.

5. The system of claim 2, wherein the first memory device further includes a first memory controller configured to transfer the device information to the switch.

6. The system of claim 2, wherein the switch is further configured to
determine a grade of the host based on receiving the memory allocation request from the host and generate host grade information indicating the grade of the host, and
generate the memory device grade information indicating the grade of the first memory device when the first memory device is connected to the switch.

7. The system of claim 1, wherein
the memory allocation request includes category information of an application that is executed on the host, and
the switch is further configured to determine a grade of the host as one of first to N-th grades (N is 2 or greater integer) based on the category information of the application.

8. The system of claim 7, wherein the switch is further configured to
allocate the first memory device to the host based on the grade of the host being a first grade,
allocate the second memory device to the host based on the grade of the host being a second grade, and the grade of the second memory device is less than the grade of the first memory device.

9. A method comprising:
receiving device information from a plurality of memory devices including a first memory device and a second memory device that is different from the first memory device;
determining grades of the plurality of memory devices based on the device information;
receiving a memory allocation request including category information of an application that is executed on a host from the host;
determining a grade of the host based on the category information; and
allocating at least one of the plurality of memory devices to the host based on grade information of the host and grade information of the plurality of memory devices.

10. The method of claim 9, wherein the determining of the grades of the plurality of memory devices comprises:
determining a grade of the first memory device as one of first to M-th grades (M is 2 or greater integer) based on the device information received from the first memory device; and
generating memory device grade information indicating the grade of the first memory device.

11. The method of claim 9, wherein the device information includes at least one of device type information, bandwidth information, latency information, cell capacity information, voltage information, and temperature information corresponding to the first memory device.

12. The method of claim 10, wherein
the determining of the grade of the host comprises:
determining the grade of the host based on the memory allocation request received from the host; and
generating host grade information indicating the grade of the host, and
the determining of the grades of the plurality of memory devices comprises:
generating the memory device grade information indicating the grade of the first memory device based on the first memory device being connected to the switch.

13. The method of claim 9, wherein the determining of the grade of the host comprises determining a grade of the host to be one of first to N-th grades (N is 2 or greater integer) based on the category information.

14. The method of claim 13, wherein the allocating of at least one of the plurality of memory devices to the host comprises:
allocating the first memory device to the host based on the grade of the host being a first grade; and
allocating the second memory device to the host based on the grade of the host being a second grade, and the grade of the second memory device being less than the grade of the first memory device.

15. A system comprising:
a plurality of memory devices including a first memory device and a second memory device that is different from the first memory device;
a plurality of hosts including a first host configured to communicate with the plurality of memory devices and a second host that is different from the first host; and
a switch connecting the plurality of hosts and the plurality of memory devices, the switch configured to
receive memory allocation requests from at least two of the plurality of hosts, and
allocate, in response to the received memory allocation requests, at least one of the plurality of memory devices to each of the plurality of hosts based on grade information of the plurality of hosts and grade information of the plurality of memory devices.

16. The system of claim 15, wherein the switch is further configured to
receive device information from the first memory device,
determine a grade of the first memory device to be one of first to M-th grades (M is 2 or greater integer) based on the device information received from the first memory device, and
generate memory device grade information indicating the determined grade of the first memory device.

17. The system of claim 16, wherein the device information includes at least one of device type information, bandwidth information, latency information, cell capacity information, voltage information, and temperature information corresponding to the first memory device.

18. The system of claim 16, wherein the switch includes a device information register configured to store first device information indicating status of the first memory device and the grade information of the first memory device.

19. The system of claim 15, wherein
the memory allocation request includes
category information of an application that is executed on the first host, and
the switch is further configured to
determine a grade of the first host to be one of first to N-th grades (N is 2 or greater integer) based on the category information of the application.

20. The system of claim 19, wherein
category information of the first host is different from category information of the second host,
the switch is further configured to allocate the first memory device to the first host and allocate the second memory device to the second host, based on the grade of the first host being greater than the grade of the second host, the grade of the first memory device being greater than or equal to the grade of the second memory device, and based on the grade of the first host being less than the grade of the second host and the grade of the first memory device being less than or equal to the grade of the second memory device.
